(19) United States
(12) Patent Application Publication
(10) Pub. No.: US 2023/0373123 A1
(43) Pub. Date: Nov. 23, 2023

(54) CUTTING DEVICE AND FABRICATING TABLE HAVING THE DEVICE

(71) Applicant: ALPLA Werke Alwin Lehner GmbH & Co. KG, Hard (AT)

(72) Inventors: Florian MÜLLER, Hard (AT); Simon SEPPI, Hohenems (AT); Manuel FÄSSLER, Lustenau (AT)

(21) Appl. No.: 18/027,516

(22) PCT Filed: Sep. 20, 2021
(86) PCT No.: PCT/EP2021/075808

§ 371 Date: Mar. 21, 2023

(30) Foreign Application Priority Data
Sep. 21, 2020 (CH) 01191/20

(51) Int. Cl. B26D 3/16; B26D 1/147; B26D 7/06

(52) U.S. Cl. CPC B26D 3/166; B26D 1/147; B26D 7/0625

(57) ABSTRACT

Disclosed is a cutting device (1) for fabricating a fiber-based shell (10). The cutting device (1) has a first mandrel (20) which can rotate about an axis of rotation (D1) and on which the fiber-based shell (10) can be arranged. The cutting device (1) has a knife (30) which can rotate about an axis of rotation (M). The axis of rotation (D) of the first mandrel (20) and the axis of rotation (M) of the knife (30) are adjacent to each other.

The present invention relates to a cutting device for fabricating a fiber-based shell and a fabricating table comprising a cutting device for fabricating a fiber-based shell according to the preamble of the independent claims.

Different containers for holding liquid are known from the prior art. For example, glass bottles or plastic bottles for holding beverages have become established. Containers which are made of fiber-based material have likewise already been proposed.

A fiber-based container was proposed in WO 2012/139590 A1. To produce this container, what is known as pulp is introduced into a mold and within this mold pressed by a flexible balloon against a corresponding wall and compressed accordingly.

Pulp is a mixture of fibers and water, in particular natural fibers such as hemp fibers, cellulose fibers or flax fibers or a mixture thereof. The pulp may have additives, as known, for example, from PCT/EP2019/076839, which, for example, improve curing of the compressed pulp or have an influence on the later appearance or generally change the properties of the pulp or of the later container.

In the case of these containers, there is a risk of them softening due to liquid stored in the container and, for example, becoming leaky or of substances diffusing out of the container into the liquid.

It has been proposed to provide such fiber-based containers with an inner layer made of plastic, in particular to arrange within the fiber-based container a plastic bottle which can assume corresponding barrier functions. The fiber-based container thus only provides a shell for a thin-walled plastic container. Such a combination has become known from WO 2018/167192 A1.

It is known that certain inaccuracies can arise during production not only in the case of fiber-based containers provided with an inner layer made of plastic in a further method step, that is to say in fiber-based shells, but also in the case of fiber-based containers provided with no such layer. Since the containers and/or shells are formed in a negative mold, a very high dimensional fidelity can be achieved in relation to their outer contour. Depending on the specific properties of the pulp from which the container/shell is formed, the inner contour or the inner surface of the container/shell is subject to differently sized deviations. These are typically negligible with the exception of deviations in the region of an opening of the container into which a plastic container is later introduced and/or on which a container closure is arranged. As a result of the material properties of the pulp, an upper, final edge of the opening is subject to greater tolerances and is often fibrous. This is disadvantageous, in particular, since this forms an interface to the already mentioned plastic containers and/or container closures and this interface must be designed to be dimensionally accurate.

It is an object of the invention to eliminate one or more disadvantages of the prior art. In particular, a device is to be provided which makes it possible to fabricate fiber-based shells in a dimensionally accurate manner.

This object is solved by the devices defined in the independent claims. Further embodiments emerge from the dependent claims.

In the present case, a fiber-based shell is understood to mean an object into which a further object, for example a plastic container, can be introduced. A fiber-based container is understood to mean a container in which a substance, for example a liquid, can be introduced directly. A fiber-based container typically has a base, a container body and a container neck to which the container opening is connected. A fiber-based shell can also have the aforementioned elements, but this is not mandatory. A fiber-based shell can also be, for example, simply tubular and have two openings. In this case, it is conceivable that a container to be inserted into this shell will protrude from the fiber-based shell both with its base and with its container neck. In relation to an opening to be fabricated, container openings as well as openings on tubular ends of a shell thus fall.

A cutting device according to the invention for fabricating a fiber-based shell, in particular a fiber-based container, has a first mandrel which can rotate about an axis of rotation and on which the fiber-based shell can be arranged. Furthermore, the cutting device has a knife which can rotate about an axis of rotation. The axis of rotation of the first mandrel and the axis of rotation of the knife are adjacent to each other, in particular at an angle of less than 10° relative to each other, preferably less than 5° relative to each other, preferably parallel to each other.

It goes without saying that the knife is arranged opposite the mandrel in the direction of one of the axes of rotation, that is to say along the axis of rotation.

The mandrel is preferably essentially circular-cylindrical. In the direction counter to a receiving direction of the fiber-based shell, however, the mandrel can also be at least partially conical in order to facilitate the insertion of the mandrel into the fiber-based shell, or bringing the shell onto the first mandrel. The receiving direction of the fiber-based shell is the direction in which the fiber-based shell must be moved in order to arrange it on the mandrel.

This arrangement makes it possible for the knife and the mandrel to roll on each other, thus carrying out a cutting movement. This makes it possible to separate a fiber-based shell which is arranged between the mandrel and the knife and to create a defined cut edge on the fiber-based shell.

In the present case, adjacent to each other means that the axes of rotation run substantially in the same direction.

As an alternative to the mandrel described here, it can be provided to design this mandrel such that it has a variable diameter. For this purpose, the mandrel can be designed, for example, as a spreader, with radially movable segments or sectors.

It can be provided that the first mandrel has a drive device.

By means of the drive device, a fiber-based shell applied to the first mandrel can be rotated together with the first mandrel. By means of such a rotation, a complete circumference of the fiber-based shell can be guided past a specific position, in particular at the position at which the rotatable knife engages. In addition, it is possible to guide a specific location of the circumference of the fiber-based shell past the knife several times by continuing rotating. This enables a very gentle cutting of the fiber-based shell.

It can be provided that the knife is mounted so as to be freely rotatable and can be driven or is driven by contact with the mandrel or a fiber-based shell arranged on the mandrel.

This passive driving of the knife ensures that no relative movements take place between the knife and the respective surface to be severed, since due to the friction of the knife on the mandrel or on the fiber-based shell to be cut, this is driven at exactly the circumferential speed of the fiber-based shell, disregarding slippage, and thus the circumferential speed of the fiber-based shell and also the circumferential speed of the knife coincide. The tearing out of fibers due to a speed difference between the knife and the surface of the fiber-based shell is reduced.

However, in addition to the drive device of the mandrel or as an alternative to it, it can be provided that the knife has a drive device. Accordingly, the mandrel and the knife can be driven simultaneously. A specific slippage between the knife and the fiber-based shell can thereby be set. Preferably, this is reduced to zero.

It is also possible to drive the mandrel and thus the fiber-based shell by the knife.

The rotatable knife is preferably arranged displaceably relative to the first mandrel in such a way that a distance between the axis of rotation of the first mandrel and the axis of rotation of the knife is adjustable.

The mandrel can thus, in particular together with its drive device, be arranged in a stationary manner, for example, relative to a fabricating table. This makes it possible that to apply the fiber-based shell to the mandrel only the knife needs to be distanced from the mandrel. In addition, it is easy to respond to different wall thicknesses of the fiber-based shell.

For this purpose, it can be provided that the knife is arranged on a carriage or on a pivotable bracket.

The arrangement on a carriage makes it possible to advance the knife to the mandrel or to distance it therefrom in a linear movement. The alternative arrangement on a pivotable bracket makes it possible to advance the knife towards the mandrel or to distance it therefrom with a pivoting movement. The carriage can be designed such that at least a slight pivoting for centering the knife and/or for compensating tolerances of the fiber-based shell to be cut is made possible. For this purpose, pretensioning elements, for example, can be provided on the carriage.

In this case, it can be provided, for example, to arrange the knife with a pretension in the direction of the mandrel and to guide the mandrel past the knife, wherein said mandrel rotates on the knife while it is being guided past. In this case, the knife is located in a clear space in front of the mandrel and is moved away from the mandrel by the impact on the mandrel or on a fiber-based shell according to the shell's diameter, wherein at the same time the knife is driven by the mandrel and the fiber-based shell is separated.

The cutting device can have a second mandrel which can rotate about an axis of rotation and on which a further fiber-based shell can be arranged. The axis of rotation of the second mandrel and the axis of rotation of the knife are adjacent to each other, in particular at an angle of less than 10° relative to each other, preferably less than 5° relative to each other, preferably parallel to each other.

By means of the arrangement of a second mandrel, two fiber-based shells can be simultaneously fabricated together with a single knife.

The second mandrel can have a drive device.

By means of the drive device, a fiber-based shell applied to the second mandrel can be rotated together with the second mandrel. By means of such a rotation, a complete circumference of the fiber-based shell can be guided past a specific position, in particular at the position at which the rotatable knife engages. In addition, it is possible to guide a specific location of the circumference of the fiber-based shell past the knife several times by continuing rotating. This enables a very gentle cutting of the fiber-based shell.

The first mandrel and the second mandrel preferably have a common drive device.

This ensures that both mandrels and thus both fiber-based shells applied on the respective mandrel have the same rotational speed and thus the same circumferential speed.

When the cutting device is designed with two mandrels, it can be provided that the knife is arranged on a rotary plate for centering between the first mandrel and the second mandrel.

A rotation point of the rotary plate is arranged in the region of an axis of symmetry between the two mandrels, wherein this region can extend on both sides of the axis of symmetry up to the respective mandrel.

By arranging the knife on a rotary plate, it is possible to position it uniformly in relation to the two mandrels. In particular, a distance between the axis of rotation of the first mandrel and the axis of rotation of the knife as well as a distance between the axis of rotation of the second mandrel and the axis of rotation of the knife can be set identically by such an arrangement.

A rotational or pivoting movement of the rotary plate can be limited by resilient stops such as springs. It is conceivable that in both rotational or pivoting directions a spring is pretensioned, which presses the knife and the rotary plate into a neutral position. The neutral position corresponds to an orientation of the knife and the rotary plate on the axis of symmetry.

This makes it possible that, for example, in the absence of a fiber-based shell on one of the two mandrels, the non-occupied mandrel is not excessively loaded, since the knife is pressed into the axis of symmetry by the corresponding spring and thus moved in the direction of the second, occupied mandrel.

This also makes it possible for the resilient stops to effect a compensation which compensates for fluctuations in the wall thickness of the fiber-based shell.

A diameter of the first mandrel and, if applicable, of the second mandrel can in each case be greater than an inner diameter of the fiber-based shell which is to be applied to the respective mandrel.

Such an embodiment enables the fiber-based shell to be held on the respective mandrel without additional holding elements being required. The fiber-based shell is thus held on the respective mandrel only by clamping action.

In the case of the mandrel being designed with a variable diameter, it can be provided that a first diameter is smaller than an inner diameter of the fiber-based shell and a second diameter is greater than an inner diameter of the fiber-based shell. The mandrel can thus be introduced into the fiber-based shell without force and without friction, and the shell can subsequently be held by the enlarged diameter of the mandrel.

The cutting device can have one or more stripping devices for stripping away a cut-off part of the fiber-based shell. These are arranged in a receiving direction after the knife on the first and optionally on the second mandrel.

In a receiving direction before the knife, a fan nozzle for each mandrel can be arranged on the cutting device, in particular below the respective mandrel. In the present case, an arrangement below the respective mandrel means that a nozzle opening of the fan nozzle is arranged in front of the mandrel in the receiving direction but at a radial distance from the mandrel so that the fan nozzle does not collide with a fiber-based shell arranged on the respective mandrel.

The fan nozzle makes it possible to blow a cut-off part, which is stripped off from the respective mandrel, out of a working chamber in a desired direction in order to collect the part in a corresponding vessel, for example.

The first and/or the second mandrel can each have a resilient, in particular cut-resistant, coating, in particular a plastic coating. This can be present, for example, as a polyester-urethane rubber.

By means of a coating, the knife wearing out too quickly and/or becoming blunt can be delayed.

Each mandrel may have a groove formed corresponding to the cutting edge of the knife. The groove is designed such that the knife projects beyond the wall thickness of the fiber-based shell to be cut, that is to say protrudes into an envelope curve of the mandrel. Due to the groove opposite the knife, the knife is freed and can be moved behind the surface of the mandrel without damaging this surface.

This configuration ensures that the fiber-based shell can be completely severed and the surface of the mandrel not be damaged.

A further aspect of the present invention relates to a fabricating table for fabricating fiber-based shells. The fabricating table comprises a cutting device for fabricating a fiber-based shell, in particular a cutting device as described herein. The fabricating table has a first conveying device for feeding non-fabricated fiber-based shells and a second conveying device for conveying away fabricated fiber-based shells.

This embodiment enables the continuous processing of fiber-based shells.

In this case, it can be provided that a rotary plate for conveying the fiber-based shells to the cutting device is arranged on the fabricating table.

In particular, the rotary plate is provided to convey fiber-based shells from the first conveying device to the cutting device and from the cutting device to the second conveying device.

The formation of a fabricating table with a rotary plate simplifies its design and enables continuous conveying of fiber-based shells and thus continuous processing.

A further aspect of the invention relates to a fiber-based shell, in particular a fiber-based container, wherein said item has a knife-cut fabrication edge.

This enables the provision of dimensionally accurate fiber-based shells and/or fiber-based containers for further processing.

A method for fabricating fiber-based shells has in particular the following steps:
feeding a fiber-based shell to a cutting device,
arranging the fiber-based shell on a rotatable mandrel,
advancing a rotatable knife towards the mandrel, such that the fiber-based shell to be fabricated, that is to say to be cut, is arranged between the mandrel and the knife,
rotating the mandrel about its axis of rotation, wherein the knife is driven by the rotation of the mandrel and the fiber-based shell arranged thereon and thus a part of the fiber-based shell is cut off.

In further steps, the fabricated fiber-based shell is removed from the mandrel. Next, the cut-off part is removed from the mandrel in particular with a stripping device and blown out of the working area by a fan nozzle arranged in front of the mandrel in the receiving direction.

The invention is explained below with reference to schematic figures by means of exemplary embodiments. These show:

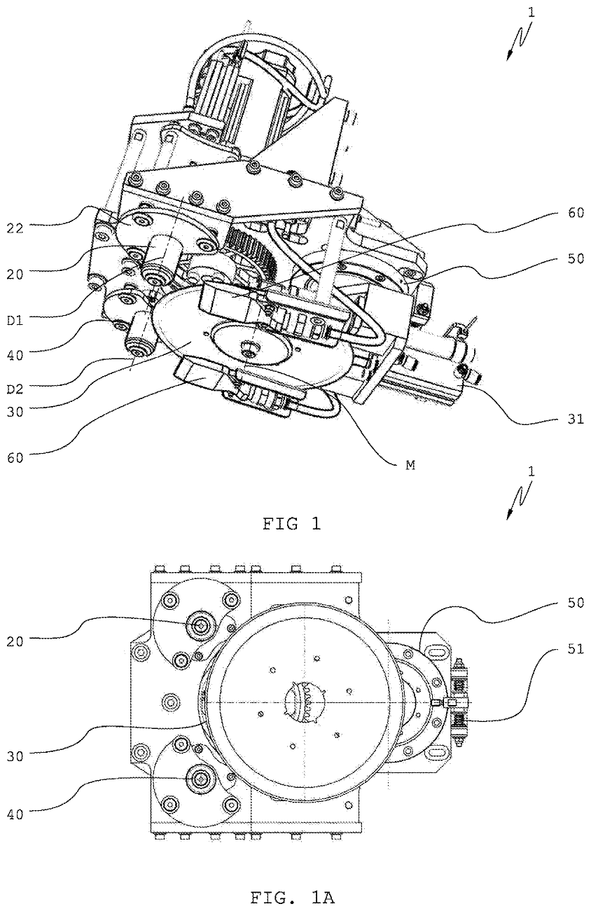

FIG. 1: a perspective view of a cutting device;

FIG. 1A: a bottom view of the cutting device from FIG. 1;

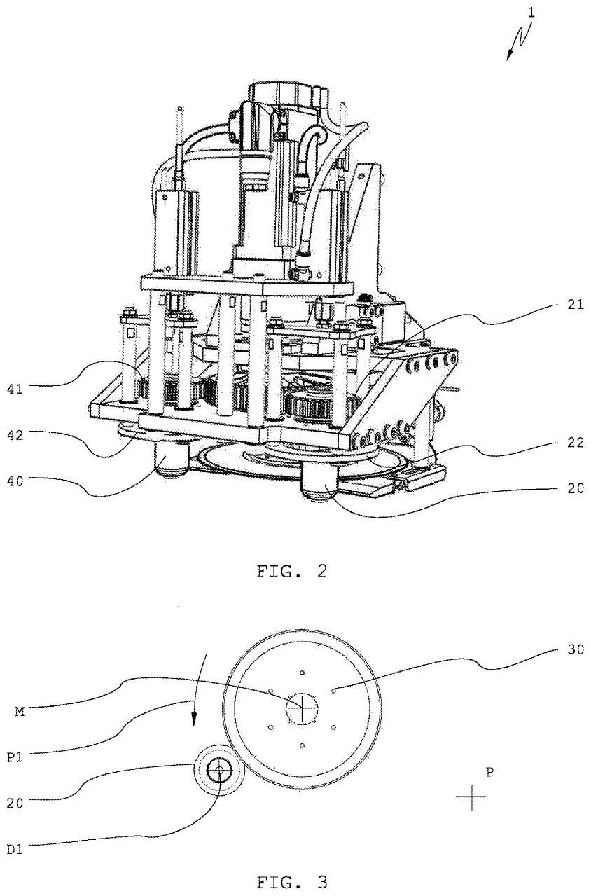

FIG. 2: a perspective view of the cutting device from FIG. 1;

FIG. 3: a schematic view of a knife/mandrel combination;

FIG. 4: a schematic view of a further knife/mandrel combination;

FIG. 5 to FIG. 10: a fabrication process;

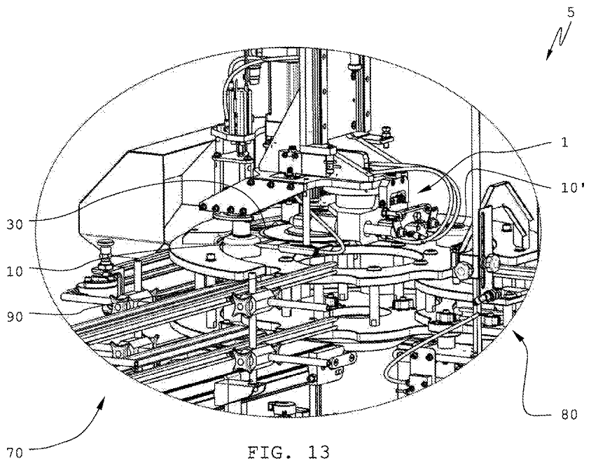

FIG. 11: a plan view of a fabricating table;

FIG. 12: a perspective view of a further fabricating table;

FIG. 13: a detailed view of the fabricating table from FIG. 12.

FIG. 1 shows a perspective view of a cutting device 1. The cutting device 1 has a first mandrel 20 and a second mandrel 40. The first mandrel 20 can rotate about the axis of rotation D1 and the second mandrel 40 can rotate about the axis of rotation D2. A knife 30 is arranged essentially on an axis of symmetry between these two mandrels 20 and 40. The knife 30 is arranged rotatably about its axis of rotation M.

The knife 30 is also arranged linearly displaceably on a carriage 31. The carriage 31 is in turn arranged rotatably on a rotary plate 50. The rotary plate 50 and the mandrels 20 and 40 are arranged on a common support, not indicated in greater detail.

In the present illustration according to FIG. 1, two fan nozzles 60 are arranged below the knife 30, wherein each fan nozzle 60 is assigned to a mandrel 20, 40. The fan nozzles 60 are each distanced radially from the corresponding mandrel 20, 40.

A stripping device 22 is assigned to the first mandrel 20. A stripping device 42 is also assigned to the second mandrel 40. The stripping devices 22 and 42 are each displaceably arranged along the first axis D1 and the second axis D2, respectively.

FIG. 1A shows a view of the underside of the cutting device 1 from FIG. 1. In this figure, the knife 30 is arranged centrally in relation to the two mandrels 20, 40, but not yet in engagement with fiber-based shells potentially located on the mandrels. As already explained with regard to FIG. 1, the entire knife 30 is arranged on a rotary table 50. Two resilient stops, which are designed as springs in the present case, are arranged on this rotary table 50. Together, these form a spring compensation 51. The spring compensation 51 limits a rotary movement of rotary plate 50 and presses the rotary plate 50 into the neutral position shown here.

FIG. 2 shows a perspective view of the cutting device 1 from FIG. 1. In the illustration according to FIG. 2, the drive devices 41 and 42 of the respective mandrels 20 and 40 can be seen. In the present case, the two drive devices 41 and 21 are each designed as toothed wheels, which are moved via a central gear wheel driven by a motor. The mandrels 20 and 40 thus have a common drive device.

It can also be seen from FIG. 2 that a pneumatic cylinder is provided for moving the stripping device 22 and the stripping device 42. However, these are not indicated in greater detail here.

FIG. 3 shows a schematic view of a knife/mandrel combination consisting of a knife 30 which is mounted rotatably about an axis of rotation M and consisting of a first mandrel 20 which is mounted rotatably about an axis of rotation Dl. The knife 30 is mounted pivotably about the point P on a pivotable bracket (not shown here). By pivoting the knife 30 about the point P, the axis of rotation M can be advanced to the axis of rotation D1 of the mandrel 20. A fiber-based shell located on the mandrel 20 is thus clamped between the knife 30 and the mandrel 20. This fiber-based shell can be separated by rotating the mandrel 20.

FIG. 4 shows a schematic view of a further knife/mandrel combination consisting of a knife 30, a first mandrel 20 and a second mandrel 40. This illustration substantially corresponds to the functional principle of the cutting device 1 from FIG. 1. The knife 30 is arranged on a carriage 31 (see FIG. 1), not shown here, and is linearly displaceable along the arrow direction P2. The carriage 31 is mounted on a rotary table 50 (see FIG. 1) rotatably about the point P and pivotably in the arrow direction P3. By moving the knife 30 in the arrow direction P2 towards the mandrels 20 and 40, the knife 30 is automatically centered between the two mandrels 20 and 40. In other words, a distance between the axis of rotation D1 and the axis of rotation M corresponds to a distance between the axis of rotation D2 and the axis of rotation M.

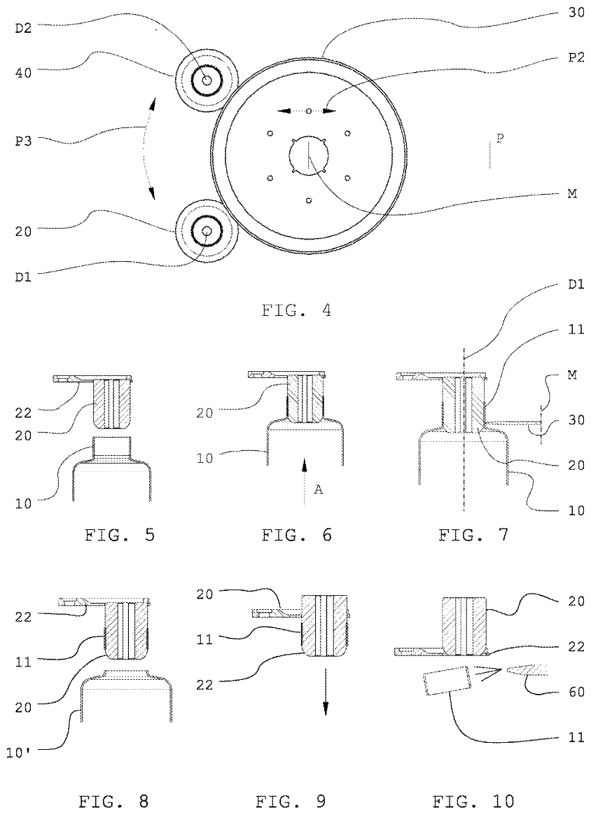

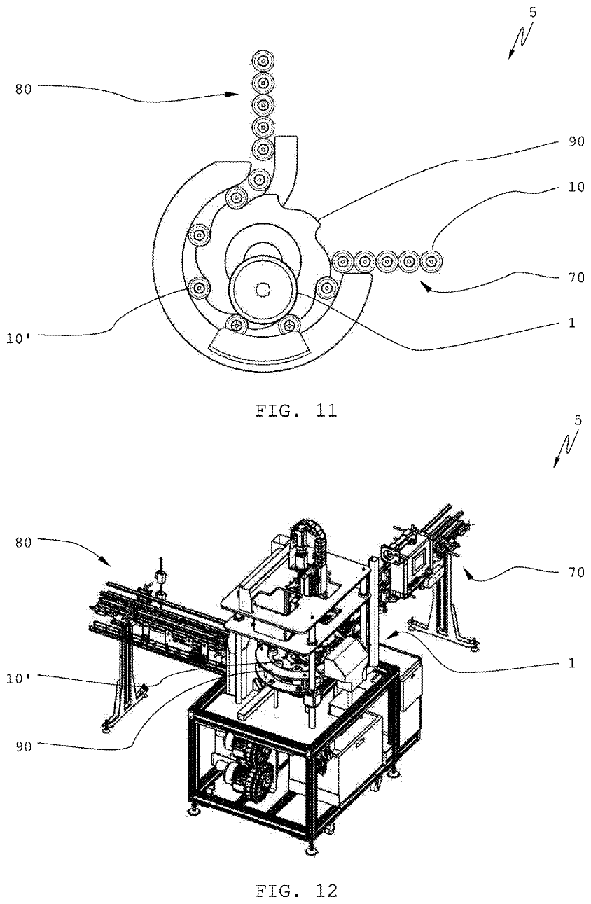

FIGS. 5 to 10 show a fabrication process. The fabrication process is explained in connection with the first mandrel 20. However, the method steps are used in exactly the same way on the second mandrel 40. In a first step, which can be seen in FIG. 5, a fiber-based shell 10 is provided relative to a first mandrel 20. The stripping device 22 can be seen on the first mandrel 20. In a second step, which can be seen in FIG. 6, the fiber-based shell 10 is positioned on the mandrel 20 in the receiving direction A. In the next step, which can be seen in FIG. 7, a knife 30, as described in FIGS. 3 and 4, is advanced towards the axis of rotation D1 with its axis of rotation M in such a way that the fiber-based shell 10 is clamped between the knife 30 and the mandrel 20. The mandrel 20 is then rotated together with the fiber-based shell 10 arranged thereon. This rotation also drives the knife 30, which rotates about its axis of rotation M. As a result of this rotation and uniform pressure of the knife 30 on the fiber-based shell 10, a part 11 of the fiber-based shell 10 is cut off from the latter. The now fabricated fiber-based shell 10′ is subsequently removed from the mandrel 20 counter to the receiving direction A (see FIG. 6), and only the cut-off part 11 remains on the mandrel 20, as can be seen in FIG. 8. In the subsequent step illustrated in FIG. 9, the stripping device 22 is moved counter to the receiving direction A, which is illustrated by the arrow in FIG. 9. Due to this movement, the cut-off part 11 is stripped off the mandrel 20. As soon as the cut-off part 11 is detached from the mandrel 20, air is blown into the fan nozzle 60 and the part 11 is blown out of the working area with this air blast. Next, the stripping device 22 is moved back into the original position according to FIG. 5. The method described here naturally also applies to a second mandrel.

FIG. 11 shows a plan view of a fabricating table 5. The fabricating table 5 has a cutting device 1, wherein this cutting device 1 has two mandrels. A plurality of fiber-based shells 10 is located on a conveyor 70, not shown in greater detail here. These fiber-based shells 10 are transferred from the conveyor 70 to a rotary plate 90 which moves them towards the cutting device 1. In the cutting device 1, the fiber-based shells 10 are fabricated as described in the present case. The finished fiber-based shells 10′ are moved further with the rotary plate 90 to a conveyor 80 (not shown in more detail) and delivered to it.

FIG. 12 shows a perspective view of a fabricating table 5. The fabricating table 5 has a cutting device 1, wherein this cutting device 1 has two mandrels. A plurality of fiber-based shells is conveyed with a conveyor 70 to a rotary plate 90 and transferred. The rotary plate in turn conveys them towards the cutting device. In the cutting device 1, the fiber-based shells are fabricated as described above. The finished fiber-based shells are moved further with the rotary plate 90 to a conveyor 80 and delivered to it.

FIG. 13 shows a detailed view of the fabricating table 5 from FIG. 12. In this illustration, two fiber-based shells 10 can be seen, which are held by the rotary plate 90 and are applied to the mandrels (not visible here). The fiber-based shells 10 are fed via the conveyor 70 to the fabricating table 5. The illustration is shown here shortly before the knife 30 of the cutting device 1 is advanced towards the mandrels. One of several fabricated fiber-based shells 10′ is shown in the right-hand region of the image. These are removed from the fabricating table 5 via the conveyor 80.

1. A cutting device (1) for fabricating a fiber-based shell (10), in particular a fiber-based container, wherein
the cutting device (1) has a first mandrel (20) which is rotatable about an axis of rotation (D1) and on which the fiber-based shell (10) is arrangeable, and has a knife (30) which is rotatable about an axis of rotation (M),
wherein the axis of rotation (D) of the first mandrel (20) and the axis of rotation (M) of the knife (30) are adjacent to each other.

2. The cutting device (1) according to claim 1, wherein the first mandrel (20) has a drive device (21).

3. The cutting device (1) according to claim 1, wherein the knife (30) is mounted so as to be freely rotatable and is drivable by contact with the mandrel (20) or a fiber-based shell (10) arranged on the mandrel (20).

4. The cutting device (1) according to claim 1, wherein the knife (30) has a drive device.

5. The cutting device (1) according to claim 1, wherein the rotatable knife (30) is arranged displaceably relative to the first mandrel (20) such that a distance between the axis of rotation (D1) of the first mandrel (20) and the axis of rotation (M) of the knife (30) is adjustable

6. The cutting device according to claim 5, wherein the knife (30) is arranged on a carriage (31) or is arranged on a pivotable bracket.

7. The cutting device (1) according to claim 1, wherein the cutting device (1) has a second mandrel (40) which is rotatable about an axis of rotation (D2) and on which a further fiber-based shell (10) is arrangeable, wherein the axis of rotation (D) of the second mandrel (20) and the axis of rotation (M) of the knife (30) are adjacent to each other.

8. The cutting device (1) according to claim 7, wherein the second mandrel (40) has a drive device (41).

9. The cutting device (1) according to claim 7, wherein the knife (30) is arranged on a rotary plate (50) for centering between the first mandrel (20) and the second mandrel (40).

10. The cutting device (1) according to claim 1, wherein a diameter of the first mandrel (20) and optionally of the second mandrel (40) is in each case greater than an inner diameter of the fiber-based shell (10).

11. The cutting device (1) according to claim 1, wherein a stripping device (22, 42) is arranged in a receiving direction (A) after the knife (30) on the first mandrel (20) and optionally on the second mandrel (40).

12. The cutting device (1) according to claim 1, wherein a fan nozzle for the mandrel (20, 40) is arranged in a receiving direction (A) before the knife (30), in particular below the respective mandrel (20, 40).

13. The cutting device (1) according to claim 1, wherein the mandrel (20, 40) has a resilient, in particular cut-resistant, coating.

14. The cutting device (1) according to claim 1, wherein the mandrel (20, 40) has a groove which is shaped corresponding to the cutting edge of the knife so that the knife projects beyond the wall thickness of the fiber-based shell to be cut.

15. A fabricating table (5) for fabricating fiber-based shells (10) comprising a cutting device for fabricating a fiber-based shell (10), in particular a cutting device (1) according to claim 1, wherein the fabricating table (5) has a first conveying device (70) for feeding non-fabricated fiber-based shells (10) and has a second conveying device (80) for conveying away fabricated fiber-based shells (10′).

16. The fabricating table (5) according to claim 15, wherein a rotary plate (90) for conveying the fiber-based shells (10) to the cutting device (1) is arranged on the fabricating table (5).

17. A fiber-based shell (10′), in particular fiber-based container, wherein it has a knife-cut fabrication edge.

18. The cutting device (1) according to claim 1, wherein the axis of rotation (D) of the first mandrel (20) and the axis of rotation (M) of the knife (30) are at an angle of less than 10° relative to each other.

19. The cutting device (1) according to claim 18, wherein the axis of rotation (D) of the first mandrel (20) and the axis of rotation (M) of the knife (30) are at an angle of less than 5° relative to each other.

20. The cutting device (1) according to claim 18, wherein the axis of rotation (D) of the first mandrel (20) and the axis of rotation (M) of the knife (30) are parallel to each other.
